(19) United States
(12) Patent Application Publication
(10) Pub. No.: US 2002/0025457 A1
(43) Pub. Date: Feb. 28, 2002

(54) Electrical energy storage

(76) Inventors: Peter Jeremy Dodd, Chalfont St. Peter (GB); Alan Stockwell, Woking (GB); Ian Duckels, Basingstoke (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 09/843,936

(22) Filed: Apr. 27, 2001

Related U.S. Application Data
(63) Continuation of application No. PCT/GB99/03547, filed on Oct. 27, 1999.

(30) Foreign Application Priority Data
Oct. 27, 1998 (GB) 9823509.6
Feb. 4, 1999 (GB) 9902543.9

(51) Int. Cl. H01M 8/00; C25B 9/00; C25B 1/02; H01M 12/00

(52) U.S. Cl. 429/9; 204/275.1; 204/269; 137/561 R; 204/278; 204/270; 205/343; 429/13

(57) ABSTRACT

A system and method for the storage of electrical energy or of hydrogen, the method includes the steps of (a) electrolysis of water to yield hydrogen, (b) reaction of the hydrogen from step (a) with carbon dioxide to from at least one storage compound; (c) storage of the storage compound; and (d) subsequent conversion of the storage compound back to hydrogen or use of the storage compound to fuel an engine, such as an internal combustion engine, or to generate electricity directly or indirectly. One storage compound is methanol.

This invention relates to the storage of electrical energy, in particular to systems and methods for storing electrical energy in the form of chemical bonds, more particularly chemical bonds formed by reaction of hydrogen and carbon dioxide.

The rate of generation of electricity cannot always readily be matched with demand. For example, if electricity is generated using solar energy, maximum electricity generation occurs on warm sunny days whereas maximum electricity demand may occur when it is dark and/or cold. Similar problems are encountered with other forms of electricity generation, in particular other forms of generation such as wind or wave power where the rate of production of electricity can vary unpredictably. Even with conventional power stations which feed electricity into the national grid, electricity demand is much higher during the day than during the night. In an attempt to overcome these problems, various methods have been used for the storage of electricity.

Electrical energy can be stored in electrochemical batteries which store electrical energy in the form of chemical energy. Alternatively, electricity can be used, for example, to electrolyse water to produce hydrogen and oxygen and then the hydrogen can be stored in some way until demand for electricity rises. The stored hydrogen is then used to generate electricity to meet the increased demand. For example, the hydrogen can be stored in a pressurised vessel, adsorbed in a metal hydride hydrogen gas adsorption storage system or cooled until it liquefies and later released for use in a hydrogen fuel cell to generate electricity (see for example JP 9050820 and JP 8064220). Alternatively, it has been proposed to use hydrogen generated from the electrolysis of water to chemically reduce toluene to form methylcyclohexane (Th. H. Schucan et al, Seasonal Storage of Electricity with Chemically Bound Hydrogen, Electrical Energy Storage Systems Applications Technologies Conference, Chester, UK, 16-18 June 1998). The methylcyclohexane is then stored until demand for electricity increases. Dehydrogenation of the methylcyclohexane then releases hydrogen which can be used in fuel cells for the generation of electricity.

However, the known systems for storing electricity are expensive and inflexible and do not readily lend themselves to storing varying amounts of electrical energy over time. Thus, if batteries are to be used, a large number of batteries must be provided permanently to take into account the maximum possible electrical energy which may need to be stored. Batteries also suffer from the disadvantages that they are both heavy and expensive. Similarly, hydrogen gas adsorption storage systems are inflexible and require large amounts of the adsorbing material to be ready in order to take into account the maximum possible electrical energy which may need to be stored. In addition, there are safety risks associated with the storage of hydrogen gas due to its potentially explosive nature. Similarly, the toluene-methylcyclohexane system requires the preliminary storage of large amounts of toluene, which is both toxic and flammable, in readiness for use to store electrical energy.

There is therefore still a need for a system and methods for storing electrical energy which are flexible, environmentally friendly and easily adaptable to widely differing rates of electricity generation.

According to one aspect of the present invention, there is therefore provided a system for the storage of electrical energy, said system comprising electrolysis means connectable to supplies of water and electricity and operable to provide the electrolysis of water to generate hydrogen, reaction means for receiving hydrogen generated by said electrolysis means, the reaction means providing the reaction of said hydrogen with carbon dioxide to form a storage compound, means for the supply of carbon dioxide to said reaction means, and storage means connected to said reaction means for the storage of said storage compound. As discussed below, the system preferably further comprises regeneration means for the generation of electrical energy either directly or indirectly from the storage compound.

As used herein, a storage compound is any carbon-containing compound that may be produced via the reaction of hydrogen and carbon dioxide, or from the further reaction of methanol produced by the initial reaction of carbon dioxide and hydrogen, for example an organic compound such as methanol or a higher alcohol (e.g. a C₂₋₈ alcohol), preferably methanol, a Fischer-Tropsch liquid, Mobil gasoline, or a C₁₋₈ acid, C₁₋₈-aldehyde, C₁₋₈-ether or C₁₋₈-hydrocarbon, preferably a C₁₋₄ acid, C₁₋₄-aldehyde, C₁₋₄-ether or C₁₋₄-hydrocarbon, more preferably a C₁-acid, C₁-aldehyde, C₁-ether or C₁-hydrocarbon. Methanol is an especially preferred storage compound. The storage compound may be a gas, liquid or solid under standard conditions of temperature and pressure. For ease of transfer and storage, the storage compound is preferably a liquid under standard conditions. The storage compound may be formed as a mixture with water and may optionally be stored as such a mixture rather than being separated from the water and dried.

The electricity supply may be of any form, for example the mains grid. The system may itself further comprise electricity generating means, whereby electricity may be generated and supplied to the electrolysis means. Such electricity generating means may be any conventional generating means. Examples of suitable generating means include solar panels, wind-powered generators and wave-powered generators. These are particularly suitable for use in the invention. Solar panels are preferred generating means.

The water supply means may be any source of water connectable to the system, for example the mains water supply connected via a suitable deioniser. Alternatively, a tank of de-ionised water may be provided for connection to the system. In a domestic setting, the water supply may suitably be water from the household supply which has been de-ionised using conventional methodology. Commercially available water electrolysis units often comprise a suitable deioniser so that they may use mains water.

Suitable electrolysis means for the electrolysis of water are known in the art. Suitable equipment is commercially available for example from the company Teledyne Brown Engineering of Maryland, U.S.A.

The reaction means may be any means suitable for the reaction of hydrogen with carbon dioxide to form a storage compound. Suitable means are known in the art. The means optionally comprise one or more catalysts, and are optionally supplied with heating and pressurizing means. Catalysts and conditions for the reaction of hydrogen with carbon dioxide to form suitable storage compounds are well known in the art (see for example The Catalyst Handbook, 2nd Ed., Ed. M. V. Twigg, Oxford University Press, 1997; GB 1 595 413). More than one type of catalyst may be present in the reaction means, for example in a series of catalyst beds, in order to convert any initial reaction products produced by reaction of hydrogen with carbon dioxide into the desired storage compound. For example, Fischer-Tropsch liquids may be produced by the further reaction of hydrogen with initially formed carbon monoxide, whilst Mobil gasoline may be produced by the further reaction of initially formed methanol.

Alternatively, the reaction means and the electrolysis means may be combined such that a storage compound is formed by direct electrochemical conversion is an aqueous carbon dioxide-containing electrolyte using a suitable electrode (see for example Bandi et al., J. Electrochem. Soc., 1990, 137, 2157-2160, Frese et al., J. Electrochem. Soc., 1984, 131, 2518-22, Hori et al., Chem. Lett. 1986, 897-898, Kaputsa et al., J. Electrochem. Soc., 1983, 10, 607-613, Ogura et al., Solar Energy, 1986, 37, 41-45).

The hydrogen produced in the electrolysis means may be fed directly to the reaction means. Alternatively, the system may optionally comprise means, for example a pressurised cylinder or tank, for the temporary storage of hydrogen before it is fed into the reaction means.

The carbon dioxide supply means may comprise means for the extraction of carbon dioxide from the air. Such extraction means are known in the art (Y. Hirayama et al, Proceedings of the Second International Conference on Carbon Dioxide Removal (ICCDR-2), 435-438, 419-422 (1995) and Polymeric Gas Separation Membranes by Robert E. Kesting, Ed. A. K. Fritzsche, John Wiley & Sons (1993)). For example, membranes which may be used for the extraction of carbon dioxide from gaseous mixtures are available commercially from Kvaerner Membrane Systems of Houston, Texas. Alternatively or additionally, the carbon dioxide supply means may comprise means for attachment to a store of carbon dioxide which may be stored in gaseous, liquid or solid form. Carbon dioxide is available commercially in gaseous, liquid or solid form.

The carbon dioxide supply means may alternatively comprise means for the extraction of carbon dioxide from power station flue gases or other industrial exhaust gases using known methodology (see for example Carbon Dioxide Removal from Coal Fired Power Plants (Energy and Environment Vol 1) by Chris Hendriks, Kluwer Academic Publications (1994)). Typically, carbon dioxide may comprise 5-25% of such flue gases.

The storage means may be any means suitable for the storage of the storage compound, for example tanks, drums or the like. The storage means may be any suitable size taking into account the maximum amount of electrical energy it is desired to store at any one stage. For example, a system for domestic use may involve a storage means of sufficient size to merely store excess electrical energy produced from a solar panel during the course of a day for generation of electricity during the night. In a larger system, a correspondingly larger store may be needed. The storage means may be at some distance from the reaction means and the system may further comprise one or more pumps or other suitable means for the transfer of the storage compound from the reaction means to the storage means. For example, in a domestic system, the storage means may comprise a tank buried in the garden of the house, whilst the electrolysis and reaction means may be located inside the house or garage.

A preferred embodiment of the system further comprises regeneration means for the generation of electrical energy either directly or indirectly from the storage compound. If necessary, a pump or other suitable means may be provided to transfer the storage compound from the storage means to the regeneration means. The regeneration means may comprise a suitable fuel cell for the conversion of the storage compound directly to electrical energy. For example, U.S. Pat. No. 4,524,113 discloses a methanol fuel cell. Methanol fuel cells may be used if the storage compound is methanol. If oxygen is required for the functioning of the fuel cell, it may be in the form of oxygen from the air. Alternatively, the regeneration means may comprise a conventional internal combustion engine or other suitable generator in which the storage compound may be used as a fuel.

If carbon dioxide is produced as a by-product from the fuel cell or generator it may be recycled to the reaction means for reaction with further hydrogen. In such circumstances, the carbon dioxide supply means may comprise means for the recycling of carbon dioxide from the fuel cell or generator.

Alternatively, the regeneration means may comprise further reaction means whereby the storage compound may be converted back into hydrogen and, optionally, carbon dioxide, optionally together with a hydrogen fuel cell or other suitable means for the conversion of the hydrogen into electricity (see for example GB 1165679). If the system comprises further reaction means to convert the storage compound back into hydrogen, then the system may be used for the storage of hydrogen. Such a system for the storage of hydrogen forms a further feature of the invention. If the system is to be used for the storage of hydrogen, then the electrolysis means may be replaced by some other source of hydrogen connectable to the reaction means.

The further reaction means may be any means suitable for the conversion of the storage compound into hydrogen and optionally carbon dioxide. Suitable means are known in the art and include steam reformers. Suitable catalysts to catalyse the conversion are also known in the art. Suitable hydrogen fuel cells are also known in the art, for example those available commercially from Ballard Power Systems Inc. of British Columbia, Canada. The carbon dioxide so produced may be separated and recycled for reaction with further hydrogen. In such circumstances, the carbon dioxide supply means may comprise means for the recycling of carbon dioxide from the regeneration means.

The regeneration means may also comprise means whereby any by-products or unreacted starting materials from the conversion of the storage compound back into hydrogen and carbon dioxide may be removed before the hydrogen is introduced into a hydrogen fuel cell. For example, means for the catalytic oxidation of carbon monoxide may be included.

The electricity generated from the storage means may be used to meet domestic or commercial demand. Alternatively, the regeneration means could comprise part of a vehicle and the electricity could be used to power the vehicle.

In another preferred embodiment, the system of the invention further comprises an internal combustion engine in which the storage compound or storage compound/water mixture may be used as a fuel. The internal combustion engine may be used to power for example a vehicle.

In another embodiment of the invention, the system further comprises a further reaction means whereby the storage compound or storage compound/water mixture may be reacted under suitable condition to produce other chemical compounds. Such compounds could be useful as fuels or could be sold as industrial feedstocks.

Preferably, the system is fully automated and its operation is controlled by a suitable control system, for example a microprocessor and the necessary circuitry.

The invention extends to a method for the storage of electrical energy utilising carbon dioxide and water, the method comprising the following steps:

(a) electrolysis of water to yield hydrogen;

(b) reaction of the hydrogen from step (a) with carbon dioxide to form at least one storage compound, optionally in a mixture with water;

(c) storage of said storage compound or storage compound/water mixture; and

(d) subsequent use of said storage compound or storage compound/water mixture to fuel an internal combustion engine or to generate electricity either directly or indirectly.

The method and system of the invention utilise readily available compounds, namely water and carbon dioxide, in the storage of electricity. Both compounds are cheap, readily available, and pose no particular storage problems. Electrical energy is stored in the form of chemical energy in the bonds of a suitable storage compound formed by the reaction of hydrogen with carbon dioxide.

The electrolysis of water may be carried out using conventional electrolysis technology. The electrolysis of water produces hydrogen which is retained for further reaction and oxygen which may be released to the air. Preferably, the efficiency of the electrolysis step is about 80% or greater.

The hydrogen generated from the electrolysis step is then reacted with carbon dioxide to form a storage compound as hereinbefore defined. Water may also be produced as a by-product of the reaction. The storage compound may be a gas, liquid or solid under standard conditions of temperature and pressure. For ease of transfer and storage, the storage compound is preferably a liquid under standard conditions.

Catalysts and conditions for the reaction of hydrogen with carbon dioxide to form suitable storage compounds are well known in the art (see for example The Catalyst Handbook, 2nd Ed., Ed. M. V. Twigg, Oxford University Press, 1997; GB 1 595 413). For example, for the reaction of hydrogen and carbon dioxide to produce methanol, a temperature range of about 210-300° C., preferably 240-280° C., and a pressure of about 5×10⁶-1×10⁷ Pa (50-100 bar) preferably 6×10⁶-9×10⁶ Pa (60-90 bar) are suitable. The catalyst may be a conventional zinc oxide/copper/alumina catalyst, for example a catalyst comprising approximately 60% by weight copper, 30% by weight zinc oxide and 10% by weight alumina. Suitable catalysts include those available commercially from ICI under the trade name “51 Series”.

The carbon dioxide used in step (b) may be extracted from the air as required using known methodology. Alternatively or additionally, carbon dioxide may be stored in gaseous, liquid or solid form, ready for reaction as required. The major side product of the reaction of carbon dioxide and hydrogen is water, which may be separated from the storage compound and safely released to the environment or recycled for use in the electrolysis step. Alternatively, the water may be retained in admixture with the storage compound, for example as a useful component in a subsequent energy regeneration step. This has the advantage that separation of water from the storage compound is not necessary.

The storage compound may be purified if necessary, for example by purging of unreacted hydrogen and carbon dioxide and/or by removing water or other reaction by-products. Such purged gases may then be recycled for further use in step (b) of the method of the invention, whilst any water may be recycled for use in step (a)

Electrical energy is stored in the form of chemical energy in the bonds of the storage compound. The storage compound may be stored, for example in a storage tank, until there is a need for electricity to be regenerated by releasing the energy stored in said chemical bonds. The period of storage will depend on the circumstances but may vary from a few hours to weeks or months. The storage means may be any means suitable for the storage of such compounds, for example tanks, drums or the like. The storage means may be any suitable size taking into account the maximum amount of electrical energy it is desired to store at any one time. For example, a system for domestic use may involve a storage means of sufficient size to merely store excess electrical energy produced from a solar panel during the course of a day for generation of electricity during the day. Alternatively, it may be desired to store energy produced from solar panels (or any other source of electricity) during the summer for use in the winter, in which case larger storage means are required. The method of the invention therefore provides a flexible method for the storage of electrical energy.

When demand for electrical energy increases, the energy stored in the chemical bonds of the storage compound may be released and used to generate electricity either directly or indirectly. For example, with suitable catalysts the storage compound or storage compound/water mixture may be converted back into carbon dioxide and hydrogen in a reverse of the original formation reaction and the hydrogen then used in a fuel cell or other suitable means to generate electricity. The hydrogen may need to be further processed to ensure that it does not contain quantities of carbon dioxide or carbon monoxide which may interfere with the functioning of the fuel cell. These gases may be removed using commercially available means such as the membrane systems available from Kvaerner or by using the processes disclosed in M. Iwase and S. Kawatsu, Proceedings of the 29th International Symposium on Automotive Technology and Automation: Electric, Hydrid and Alternative Fuel Vehicles, p 295, June 1996, and Initial Conceptual Design Report, Allison Engine Company for US Dept of Energy DOE/CH/10435-01, February 1994. If oxygen is required for the functioning of the fuel cell, it may be taken from the air.

Alternatively, if suitable fuel cells are available, the storage compound may be used directly in a fuel cell. For example, methanol fuel cells are known in the art (see U.S. Pat. No. 4,524,113 for an example of a methanol fuel cell). Carbon dioxide may be one of the by-products of a methanol fuel cell.

A storage compound or a storage compound/water mixture may also be used as fuel in an internal combustion engine or other suitable generator to produce electricity.

If the storage compound is converted back into hydrogen and carbon dioxide, or if a fuel cell or generator produces carbon dioxide as a by-product, there is an added advantage in that the carbon dioxide so produced may be recycled for reaction with further hydrogen. The carbon dioxide used in step (b) may therefore comprise recycled carbon dioxide. In a preferred embodiment, the carbon dioxide in step (b) comprises recycled carbon dioxide topped up if required by carbon dioxide extracted from the air.

Both hydrogen and methanol fuel cells generate water as a by-product, which may be released to the environment or recycled for use in the electrolysis step to generate further hydrogen.

The electrical energy for use in the electrolysis of water in step (a) may be generated by any conventional generating means. However, the method of the invention is particularly suitable for use in storing electricity produced by renewable energy sources, for example solar energy, wind power or wave power, where the amount of electricity generated is highly unpredictable or varies substantially with the time of day or the time of year. The method may also be useful for the storage of electricity generated by nuclear or oil, gas or coal fired power stations during periods of low demand, ready for feeding back into the national grid at times of higher demand. Electrical energy generation using renewable energy sources is preferred.

The use of methanol as the storage compound, either alone or in admixture with water, in the methods of the invention is preferred. Methanol and water may be produced via the reaction of hydrogen with carbon dioxide. Catalysts for this reaction are well known in the art and are commercially available. Fuel cells for the direct conversion of methanol to electricity are also known. Alternatively, methanol or methanol/water mixtures may be converted back into hydrogen and carbon dioxide. The hydrogen may be used in a fuel cell whilst the carbon dioxide may be recycled for reaction with further hydrogen to generate further methanol.

According to a further feature of the present invention, there is therefore provided a further method for the storage of electrical energy, said method comprising the following steps:

(a) electrolysis of water to yield hydrogen;

(b) reaction of the hydrogen from step (a) to form a methanol/water mixture;

(c) storage of the methanol/water mixture; and

(d) subsequent use of the methanol/water mixture in an internal combustion engine or to generate electricity either directly or indirectly.

Again, the electricity used in step (a) may be generated by any conventional generating means. Electrical energy generation using renewable energy sources is preferred. In step (b), the hydrogen is preferably reacted with carbon dioxide.

Methanol is a useful chemical in its own right. Rather than use methanol generated by any of the above methods for conversion into electricity, it may be sold as an industrial feedstock or used as a fuel in for example an internal combustion engined vehicle.

In addition to methanol being a useful chemical in its own right, hydrogen is also an important industrial feedstock The storage of hydrogen gas is complicated by its potentially explosive nature and the fact that it must be stored under pressure or as a cryogenic liquid. Rather than using the hydrogen regenerated in any of the methods of the invention to power a fuel cell, it can be used for other uses, for example as an industrial feedstock.

According to a further feature of the present invention, there is therefore provided a method for the production and storage of hydrogen, said method comprising the following steps:

(a) electrolysis of water to yield hydrogen;

(b) reaction of the hydrogen from step (a) with carbon dioxide to form at least one storage compound;

(c) storage of said storage compound; and

(d) subsequent conversion of said storage compound back into hydrogen and optionally also carbon dioxide.

Again, the electricity used in step (a) may be generated by any conventional generating means. Electrical energy generation using renewable energy sources is preferred. If water is formed as a by-product of the reaction of hydrogen and carbon dioxide, the storage compound may be formed, stored and used in the form of a mixture with water.

A preferred storage compound for the storage of hydrogen is methanol, optionally in the form of a mixture with water.

The hydrogen storage method of the invention has the advantage that it is flexible and readily adaptable to the storage of varying amounts of hydrogen. Rather than being stored as a potentially explosive gas, the hydrogen is stored in the form of a storage compound or storage compound/water mixture. The storage compound may be a gas, liquid or solid under standard conditions of temperature and pressure. For ease of transfer and storage, the storage compound is preferably a liquid under standard conditions.

The use of a storage compound to store the hydrogen also has the advantage that the hydrogen can be transported whilst it is in the form of the storage compound or a storage compound/water mixture, thus avoiding the potential hazards of transporting hydrogen gas under pressure or as a cryogenic liquid.

The invention will be further illustrated, by way of example, with reference to the following Drawings:

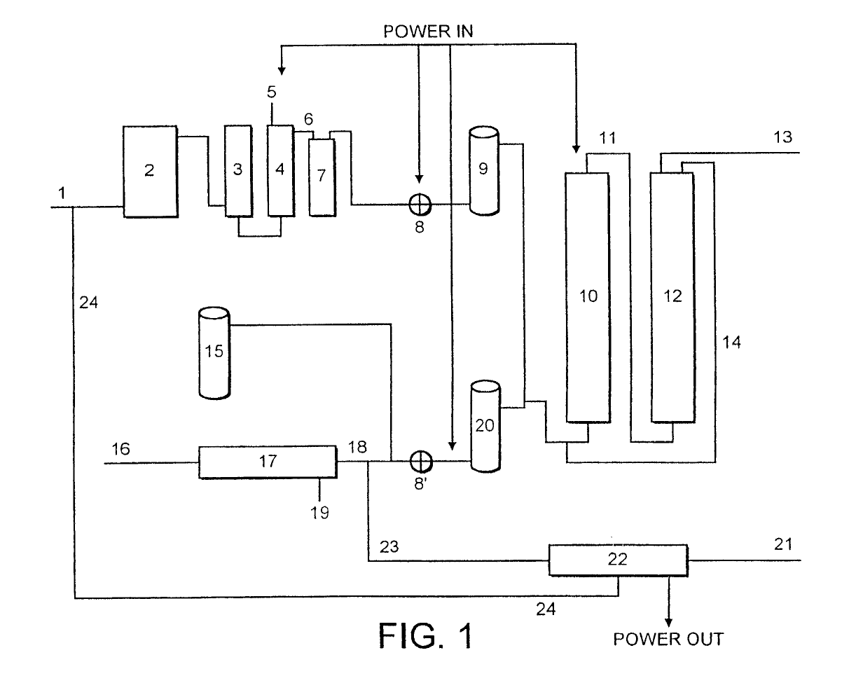

FIG. 1 illustrates in schematic form one embodiment of an electrical energy storage system according to the invention;

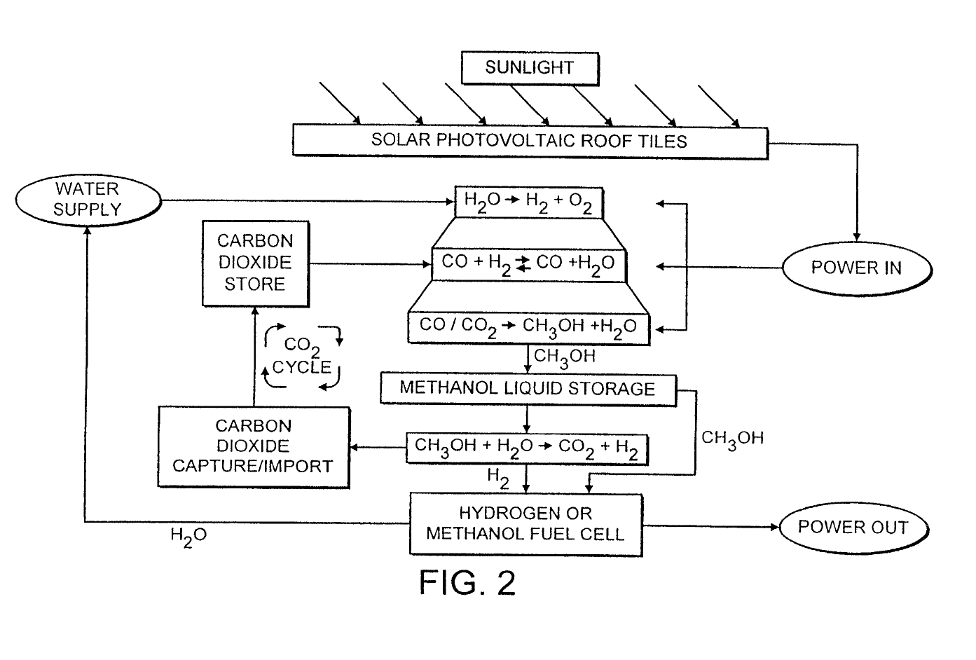

FIG. 2 illustrates in schematic form the processing steps in an embodiment of the electrical energy storage method of the invention wherein the storage compound is methanol, optionally in a mixture with water; and

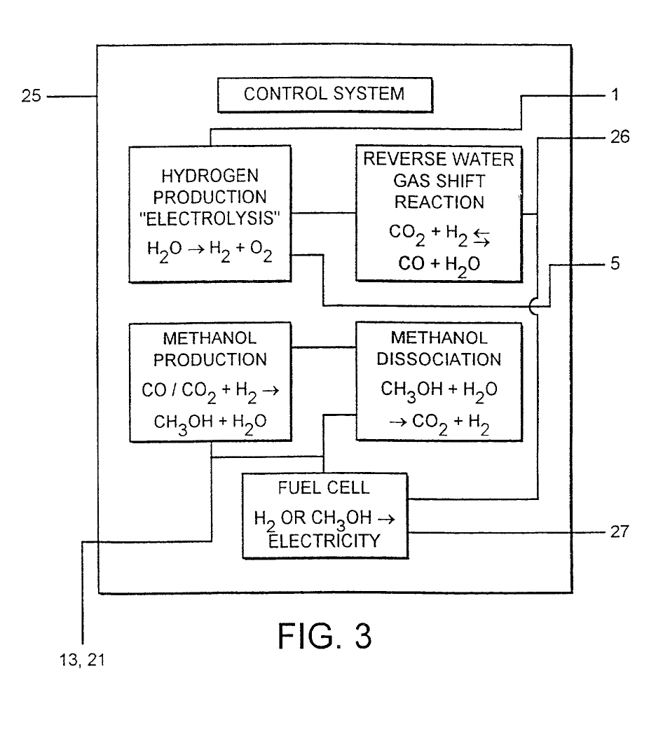

FIG. 3 illustrates in schematic form an example of the component layout for an embodiment of an automated electrical energy storage system according to the invention wherein methanol is the storage compound optionally in a mixture with water;

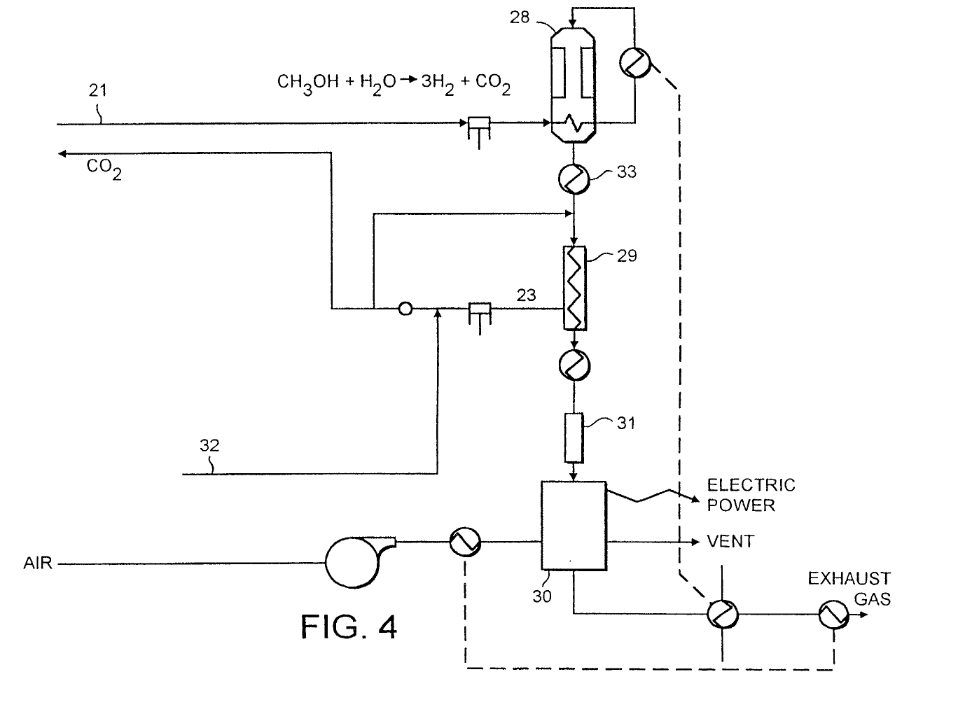

FIG. 4 illustrates in schematic form an example of the component layout of a regeneration means of an embodiment of an energy storage system according to the invention wherein methanol is the storage compound and is stored and used as a mixture with water.

FIG. 1 illustrates in schematic form one embodiment of an electrical energy storage system according to the invention. Water, for example from the mains supply, is supplied via inlet 1 to a water storage tank 2. The water is deionised in a deioniser 3 of a known type and then supplied to a hydrogen generator 4, also of a known type, comprising a unit for the electrolysis of water. In the hydrogen generator, water is electrolysed to produce oxygen, which is discharged through outlet 5, and hydrogen which is fed through outlet 6 to a dryer 7. The dryer 7 is optional, as it is not essential that the hydrogen be dried. After drying, the hydrogen is fed through a compressor 8 to a pressurised hydrogen storage means 9. The hydrogen is reacted with carbon dioxide in a microreactor 10 containing a suitable catalyst to form a storage compound, for example methanol, optionally in a mixture with water. Pipe 11 carries the storage compound or storage compound/water mixture as well as some unreacted hydrogen and carbon dioxide to purification means 12. Purified storage compound or storage compound/water mixture is fed through pipe 13 to a suitable storage means (not shown), such as a tank, whilst any unreacted gases are separated by the purification means and are recycled to the reactor 10 via pipe 14.

To generate electricity, storage compound or storage compound/water mixture is returned from the storage means via pipe 21 to regeneration means 22. The regeneration means 22 comprises a suitable fuel cell, and optionally a reactor, to convert the storage compound or storage compound/water mixture back into carbon dioxide and hydrogen. Fuel cells and reactors suitable for this purpose are known. Carbon dioxide generated by operation of the regeneration means may be recycled via pipe 23 and compressor 8′ to a pressurised storage vessel 20. Carbon dioxide is supplied to the microreactor 10 from pressurised storage vessel 20. In addition to recycled carbon dioxide, the storage vessel is supplied from an initial carbon dioxide store 15 and/or a carbon dioxide/air separation means 17. The separation means 17 may comprise a suitable membrane, plus an air supply inlet 16 and an outlet 19 for carbon dioxide-free air.

Water produced in the regeneration means 22 may be recycled via pipe 24 to the water storage tank 2.

FIG. 2 illustrates in schematic form an embodiment of the electrical energy storage method of the invention wherein the storage compound is methanol or a methanol/water mixture. Sunlight falling on solar panels is used to generate electricity. The electricity is used to electrolyse water to produce hydrogen and oxygen. The hydrogen is reacted with carbon dioxide to produce methanol or a methanol/water mixture. The carbon dioxide may have been recycled, extracted from the air or brought in from outside the system. The methanol or methanol/water mixture may be stored in a tank, and then used as required, either directly in a methanol fuel cell to produce electricity, or dissociated into hydrogen and carbon dioxide, with the hydrogen then used in a hydrogen fuel cell. In either case, electricity is generated and water is a side product. The water may be released to the environment or recycled for use in the electrolysis step if desired.

FIG. 3 illustrates in schematic form a component layout for one embodiment of an automated electrical energy storage system according to the invention wherein methanol is the storage compound. The main components of the system are provided in a cabinet which in a domestic system, it is envisaged, might be of similar dimensions to a refrigerator. Electricity supply means 25 supply electrical energy, for example solar energy, to the system. Water is introduced into the system via inlet 1. The electrical energy is used to electrolyse water to produce hydrogen and oxygen, and the oxygen is released to the atmosphere via outlet 5. The hydrogen is reacted with carbon dioxide, introduced via inlet 26, to produce methanol or a methanol/water mixture via a series of reaction steps. The methanol may be transferred via inlet and outlet means 13, 21 to and from suitable storage means (not shown) as required. The methanol or methanol/water mixture may be used directly in a methanol fuel cell to produce electricity or dissociated into hydrogen and carbon dioxide and the hydrogen used in a hydrogen fuel cell. Electricity is supplied from the system via line 27.

FIG. 4 illustrates in schematic form a component layout for a regeneration means according to one embodiment of an electrical energy storage system according to the invention. The storage compound is methanol. A mixture of methanol and water is produced and stored in a storage means (not shown). The methanol/water mixture is supplied via pipe 21 to a steam reformer 28 in which the methanol/water mixture is converted back into hydrogen and carbon dioxide. The product stream from the steam reformer which contains carbon dioxide and hydrogen passes through an air cooler 33 to remove unreacted water and a separation system 29, for example a membrane system, to remove the carbon dioxide. The recovered carbon dioxide is returned to a storage tank (not shown) for use in the production of further methanol. The recycled carbon dioxide may be topped up as necessary via pipe 32 from a source of supplementary CO₂ (not shown).

After removal of the carbon dioxide, hydrogen gas is passed through a catalytic oxidizer 31 to convert any carbon monoxide to carbon dioxide. Carbon monoxide may interfere with the functioning of the fuel cell 30. The hydrogen is then converted to electricity in a fuel cell stack 30. The exhaust from the fuel cell may be released into the atmosphere, optionally after extraction and recycling of any carbon dioxide present.

The invention will be further illustrated by reference to the following non-limiting Examples.

### EXAMPLES

The Examples illustrate the use of a domestic electrical energy storage system according to the invention which uses methanol or a methanol/water mixture to store off-peak or solar generated electricity. A typical house in Miami is used to illustrate the working of the system with varying amounts of sunlight. It is assumed that solar panels cover the whole of the house roof area in the Example.

EXAMPLE 1

| | | | | | | | | | | | Hydrogen |
|---|---|---|---|---|---|---|---|---|---|---|---|
| | | | | | | | | | | Methanol | generation/ |
| | | | | | Electricity | Electricity | | | | produced | methanol |
| | | | % efficiency | | Consumed | available | | Methanol | | (as | synthesis |
| | House | Total | of solar | | During | for | | Produced⁵ | | methanol/water | equipment |
| Incident | Roof | Incident | energy | Electricity | Daylight | methanol | Hydrogen | (as methanol) | | 50:50 mol % | Power |
| Radiation | Area | Radiation | conversion | Generated | hours³ | production | produced⁴ | litres/ | | mixture) | rating |
| kWh/m²/day | m² | kWh/day | to electricity | kWh/day | kWh | kWh | kg | day | kg/day | litres/day | kW |
| 5.0 | 130 | 650 | 17.1¹ | 111.2 | 25 | 86.2 | 1.31 | 8.4 | 6.6 | 12.1 | 8 |
| 5.0 | 100 | 500 | 33.0² | 165 | 25 | 140 | 2.13 | 13.6 | 10.8 | 19.7 | 13 |

Notes
¹The Kyocera Corporation of Japan holds the world record for conversion efficiency in a multicrystal photovoltaic cell of 17.1%. Source: Kyocera Advertising Literature.
²The Swiss Federal Institute of Technology has recently announced solar cells based on Titanium Dioxide which have efficiencies as high as 33% (New Scientist, No. 2155, p 11, 10 October 1998).
³The average house in the USA consumes 18800 kWh energy per annum. This figure has been divided by 365 days and the result split equally between day and night. Source: The North Carolina Solar Centre.
⁴Assuming an electrolysis cell efficiency of 60%. Higher Heat Value (HHV) per kg of hydrogen = 39.4 kWh.
⁵Assuming a 95% conversion yield.

Option 1: methanol used as power storage for night usage

| | | | | |
|---|---|---|---|---|
| Electricity | kWh/day | 25 | 25 | 55% Conversion methanol to |
| consumed | | | | electricity (assuming a 55% |
| during night time | | | | efficiency for a methanol fuel |
| Methanol con- | kg | 8.2 | 8.2 | cell) |
| sumed at night | | | | Conversion of methanol to |
| Deficit (−)/Excess | kg | −1.6 | 2.6 | electricity, Lower Heat Value |
| Methanol | | | | (LHV) = 5.53 kWh/kg of |
| | | | | methanol |

Option 2: off-peak electricity used to generate methanol at night

| | | | |
|---|---|---|---|
| Off-peak power consumed | kWh | 80 | 119 |
| Methanol synthesised from off-peak | kg | 6.2 | 9.2 |
| electricity | | | |
| Methanol produced from solar | kg | 6.6 | 10.8 |
| electricity | | | |
| Total methanol fuel available for use in | 1 | 16.2 | 25.2 |
| an Internal Combustion Engine (ICE) | | | |
| per day | | | |
| Methanol/water fuel available for ICE | 1 | 23.4 | 36.4 |
| per day | | | |

The amount of methanol produced and stored during the day may not be sufficient to meet the full electricity demands of a house during the night. In such situations, the shortfall in electricity may be made up using cheap nighttime electricity from the national grid. Cheap nighttime electricity may also be used to produce further methanol for storage. Stored methanol may be used to generate electricity as required, for example during the day when the cost of electricity from the national grid is higher (option 1) or may be used for some other purpose, for example in an internal combustion engine (option 2).

In situations where the amount of methanol produced and stored during the day exceeds the amount needed to generate electricity to meet nighttime demand, any excess electricity may be exported to the national grid, or the methanol stored to meet future electricity demand. Alternatively, excess methanol may be used for some other purpose, for example in a methanol fuel cell or an internal combustion engine to power a vehicle.

1. A system for the storage of electrical energy comprising electrolysis means connectable to supplies of water and electricity and operable to provide the electrolysis of water to generate hydrogen, reaction means for receiving hydrogen generated by said electrolysis means, the reaction means providing the reaction of said hydrogen with carbon dioxide to form a storage compound, means for the supply of carbon dioxide to said reaction means, and storage means connected to said reaction means for the storage of said storage compound.

2. A system as claimed in claim 1 which further comprises electricity generating means connectable to the electrolysis means to supply electricity.

3. A system as claimed in claim 1 or claim 2 further comprising regeneration means for the generation of electrical energy either directly or indirectly from the storage compound.

4. A system as claimed in claim 3 wherein the regeneration means comprise a fuel cell or generator for the generation of electrical energy directly from the storage compound.

5. A system as claimed in claim 3 wherein the regeneration means comprise further reaction means to convert the storage compound back into hydrogen and means for the generation of electrical energy from said hydrogen.

6. A system as claimed in claim 1 or claim 2 which further comprises an internal combustion engine connectable to the storage means.

7. A system for the storage of hydrogen, said system comprising reaction means providing the reaction of hydrogen with carbon dioxide to form a storage compound, means for the supply of hydrogen and carbon dioxide to said reaction means, storage means connected to said reaction means for the storage of said storage compound, and further reaction means connectable to said storage means and providing the conversion of the storage compound back into hydrogen.

8. A system for the production and storage of hydrogen, said system comprising electrolysis means connectable to supplies of water and electricity and operable to provide the electrolysis of water to generate hydrogen, reaction means for receiving hydrogen generated by said electrolysis means, the reaction means providing the reaction of said hydrogen with carbon dioxide to form a storage compound, means for the supply of carbon dioxide to said reaction means, storage means connected to said reaction means for the storage of said storage compound, and further reaction means connectable to said storage means and providing the conversion of the storage compound back into hydrogen.

9. A system as claimed in any of claims 1 to 8 wherein the storage compound is a C₁₋₈ alcohol, a Fischer-Tropsch liquid, Mobil gasoline, a C₁₋₈ acid, a C₁₋₈-aldehyde, a C₁₋₈-ether or a C₁₋₈-hydrocarbon.

10. A system as claimed in any of claims 1 to 8 wherein the storage compound is methanol.

11. A method for the storage of electrical energy utilising carbon dioxide and water, the method comprising the following steps:
(a) electrolysis of water to yield hydrogen;
(b) reaction of the hydrogen from step (a) with carbon dioxide to form at least one storage compound or a storage compound/water mixture;
(c) storage of said storage compound or storage compound/water mixture; and
(d) subsequent use of said storage compound or storage compound/water mixture to fuel an internal combustion engine or to generate electricity either directly or indirectly.

12. A method as claimed in claim 11 wherein in step (d) the storage compound or storage compound/water mixture is converted back into hydrogen and the hydrogen is used to generate electricity.

13. A method as claimed in either of claims 11 or 12 wherein a storage compound/water mixture is used in steps (c) and (d).

14. A method for the storage of electrical energy, said method comprising the following steps:
(a) electrolysis of water to yield hydrogen;
(b) reaction of the hydrogen from step (a) to form a methanol/water mixture;
(c) storage of the methanol/water mixture; and
(d) subsequent use of the methanol/water mixture in an internal combustion engine or to generate electricity either directly or indirectly.

15. A method for the production and storage of hydrogen, said method comprising the following steps:
(a) electrolysis of water to yield hydrogen;
(b) reaction of the hydrogen from step (a) with carbon dioxide to form at least one storage compound;
(c) storage of said storage compound; and
(d) subsequent conversion of said storage compound back into hydrogen.

16. A method for the storage of hydrogen, said method comprising the following steps:
(a) reaction of hydrogen with carbon dioxide to form at least one storage compound;
(b) storage of said storage compound; and
(c) subsequent conversion of said storage compound back into hydrogen.

17. A method as claimed in any of claims 11 to 16 wherein the storage compound is a C₁₋₈ alcohol, a Fischer-Tropsch liquid, Mobil gasoline, a C₁₋₈ acid, a C₁₋₈-aldehyde, a C₁₋₈-ether or a C₁₋₈-hydrocarbon.

18. A method as claimed in any of claims 11 to 16 wherein the storage compound is methanol.
